(19) United States
(12) Patent Application Publication
(10) Pub. No.: US 2005/0269159 A1
(43) Pub. Date: Dec. 8, 2005

(54) Telescopic stepladder

(76) Inventor: Cho Shien Lin, Wipu Village (TW)

Correspondence Address: PRO-TECHTOR INTERNATIONAL, 20775 Norada Court, Saratoga, CA, 95070-3018, US

(21) Appl. No.: 10/862,961

(22) Filed: Jun. 7, 2004

(51) Int. Cl. E06C 1/00

(52) U.S. Cl. 182/209

(57) ABSTRACT

Either frame of a telescopic stepladder comprises a support section, one or more sliding sections, a plurality of locking mechanisms each disposed in either locking portion of two sections and in one embodiment including a fastener adapted to fasten the side rail of one section and the side rail of the other section together, and a lower spring depressible detent adapted to lock both sections. Pushing the braces upward, moving both frames toward each other, unfastening the fasteners, unlocking the detents, and sliding down the sliding sections to a limit will retract the sliding sections with respect to the support sections or the retracted sliding sections.

### FIELD OF THE INVENTION

The present invention relates to stepladders and more particularly to a telescopic stepladder with improved characteristics.

### BACKGROUND OF THE INVENTION

Extension ladders are well known. However, telescopic stepladders are not available as far as the present inventor is aware. It is understood that a long stepladder such as one having a height more than four meter is difficult of carrying for work if the stepladder is not telescopic. Thus, it is desirable to provide a novel telescopic stepladder in order to overcome the above drawback of prior art.

### SUMMARY OF THE INVENTION

It is an object of the present, invention to provide a telescopic stepladder including two frames hingedly coupled to a top and two lower, folding braces respectively, either frame comprising a lowest support section; one or more sliding sections wherein two side rails of each section are interconnected by one or more steps; a plurality of locking mechanisms each disposed in either locking portion of two sections and including a fastener adapted to fasten the side rail of one section and the side rail of the other section together, and a lower spring depressible detent adapted to lock both sections; whereby pushing the braces upward, moving both frames toward each other, unfastening the fasteners, unlocking the detents, and sliding down the sliding sections to a limit will retract the sliding sections with respect to the support sections or the retracted sliding sections; and pulling the innermost, retracted sliding sections to a limit, locking the detents, fastening the fasteners, and pulling the frames away from each other with the braces being straightened will extend the sliding sections with respect to the support sections or the retracted sliding sections. By utilizing this telescopic stepladder, the height of the stepladder can be greatly reduced for ease of carrying and/or storage.

It is another object of the present invention to provide a telescopic stepladder including two frames hingedly coupled to a top and two lower, folding braces respectively, either frame comprising a lowest support section; one or more sliding sections wherein two side rails of each section are interconnected by one or more steps; a plurality of locking mechanisms each disposed in either locking portion of two sections and including a plurality of spring depressible detents adapted to lock both sections; a plurality of pushing blocks disposed in an outer surface of the rail, each pushing block having an inclined portion facing the detent; a sliding member secured onto the pushing blocks; and an elastic member disposed in each sliding section, the elastic member having a hooked end adapted to move in an aperture of an adjacent section when two adjacent sections have slid to a predetermined position with respect to each other; whereby pushing the braces upward, moving both frames toward each other, causing the elastic members to clear the apertures, sliding the sliding members upwardly to cause the detents to unlock two adjacent sections, and sliding down the sliding sections to a limit will retract the sliding sections with respect to the support sections or the retracted sliding sections; and pulling the innermost, retracted sliding sections to a limit, moving the elastic members in the apertures, sliding the sliding members upwardly to cause the detents to lock two adjacent sections, and pulling the frames away from each other with the braces being straightened will extend the sliding sections with respect to the support sections or the retracted sliding sections.

The above and other objects, features and advantages of the present invention will become apparent from the following detailed description taken with the accompanying drawings.

### BRIEF DESCRIPTION OF THE DRAWINGS

FIG. 1 is a perspective view of a telescopic stepladder according to the invention;

FIG. 2 is an exploded perspective view of components of a section of the stepladder;

FIG. 3 is a front view of a left portion of the stepladder in a fully extended position;

FIG. 4 is a side view of the stepladder of FIG. 3;

FIG. 5 is a side view of the stepladder in a fully retracted position;

FIG. 6 is a cross-sectional view taken along line A-A of FIG. 3 for showing an upper part of a locking portion of two adjacent sections according to a first preferred embodiment of the invention;

FIG. 7 is a cross-sectional view showing a coupling of the step to an intermediate portion of either side of a section;

FIG. 8 is a cross-sectional view taken along line B-B of FIG. 3 for showing a lower part of the locking portion of FIG. 6;

FIG. 9 is a cross-sectional view taken along line A-A of FIG. 3 for showing an upper part of a locking portion of two adjacent sections according to a second preferred embodiment of the invention;

FIG. 10 is a cross-sectional view taken along line C-C of FIG. 9, where two sections are unlocked; and FIG. 11 is a view similar to FIG. 10, where the sections are locked.

### DETAILED DESCRIPTION OF THE PREFERRED EMBODIMENTS

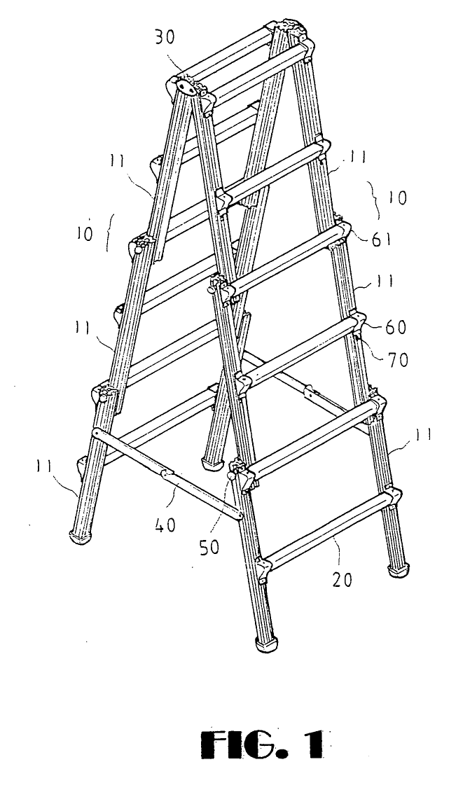

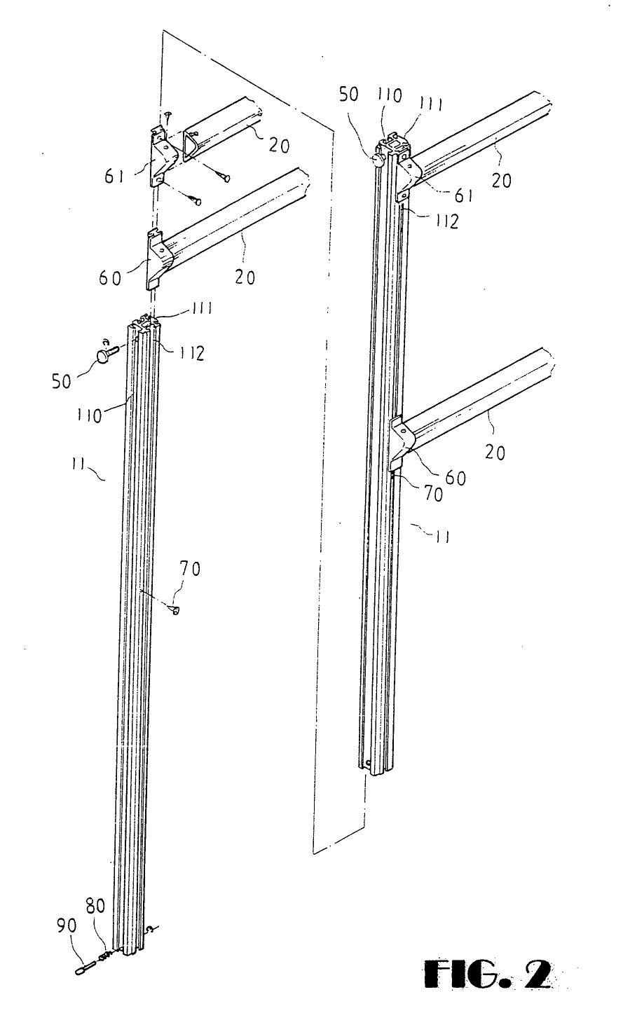

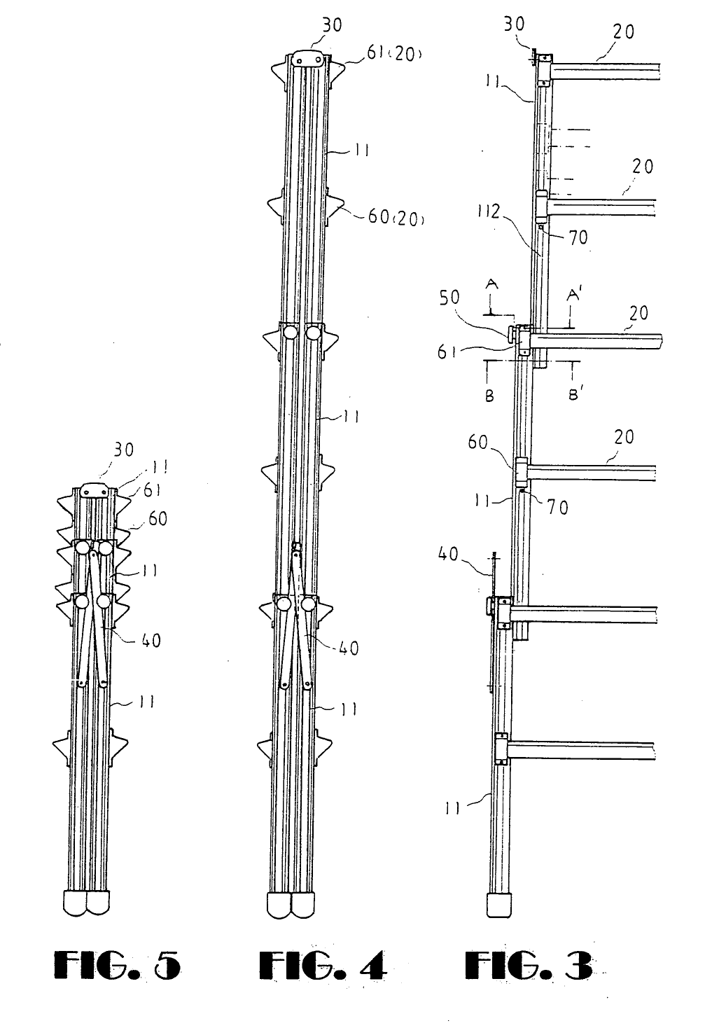

Referring to FIGS. 1 to 8, there is shown a telescopic stepladder constructed in accordance with the invention in which two frames 10 are jointed at a hinged top plate 30 and two braces 40 having toggle joint are hingedly coupled to the frames 10. Either frame 10 comprises a lowest support section 11 and two sliding sections 11. Side rails of each section 11 are interconnected by two steps 20.

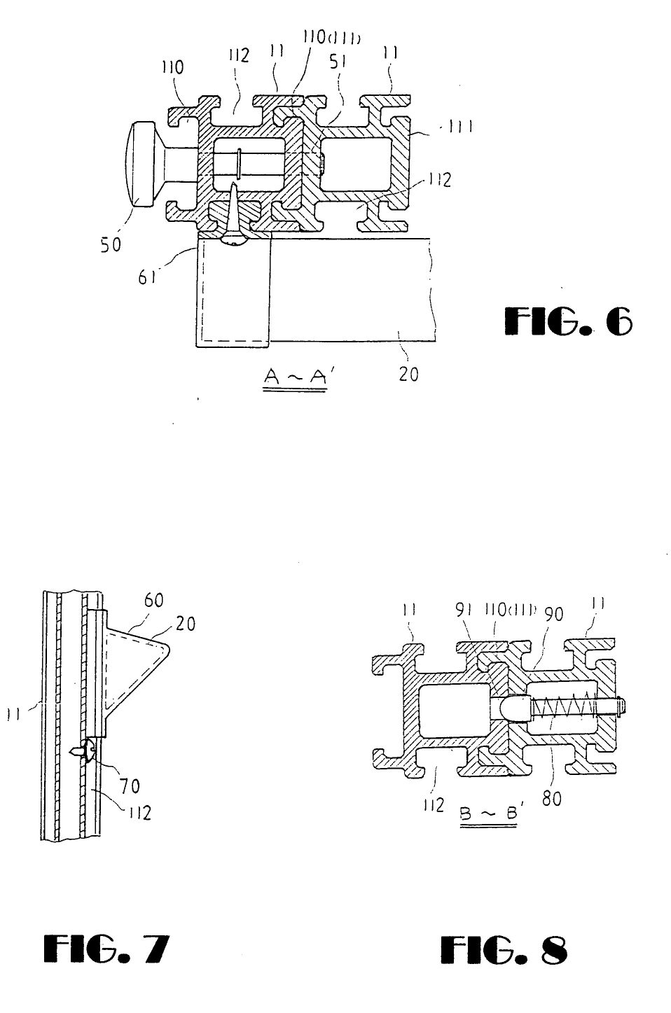

As shown in FIG. 6, the side rail 11 has a longitudinal groove 110 having a section of T at an outer side, a longitudinal projection 111 having a section of T at an inner side, and two longitudinal grooves 112 having a section of T at front and rear sides respectively. Either locking portion of two sections 11 comprises a second locking member 61 threadedly secured to the horizontal side rail 11 and the vertical step 20 in which the second locking member 61 has a longitudinal projection having a section of T matingly engaged with and threadedly secured to the front groove 112 of the side rail 11. Further, a fastener (e.g., thumb screw) 50 is driven through an aperture 51 of the inner section 11 for fastening both side rails 11 together.

As shown in FIG. 8, in a lower part of the locking portion there is provided a detent having a spring 80 thereon to form a spring depressible detent 90. The detent 90 is adapted to move in an aperture 91 in the outer section 11 for positioning. The provision of the detent 90 aims at quickly, precisely aligning the fastener 50 with the aperture 51 prior to fastening.

As shown in FIG. 7, a stop 70 is secured to the groove 112 and projected therefrom so that a bottom of a first locking member 60 for threadedly securing the step 20 to an intermediate portion of either side of a section 11 can be supported.

For folding and collapsing the stepladder, first slightly push the braces 40 upward and then move both frames 10 toward each other to form an upright one (step 1). Next, unfasten the fasteners 50 and clear the detents 90 from the apertures 91 for unfastening the lowest, innermost sections 11 and the immediately adjacent sliding sections 11 (step 2). Finally, slide down the sliding sections 11 until being stopped (step 3). Steps 2 and 3 may repeat a number of times until all sliding sections 11 are collapsed. As a result, the height of the stepladder is greatly reduced for ease of carrying and/or storage. In one preferred embodiment, a telescopic stepladder of the invention having a height of about 4 meters in a fully extended position can be reduced to about 1.3 meters after fully retracting.

For extending the stepladder, first pull the innermost sliding sections 11 outward until being stopped. Next, move the detents 90 in the apertures 91 and drive the fasteners 50 through the aperture 51 for interlocking the innermost sliding sections 11 and the immediately adjacent sections 11 (step 4). Step 4 may repeat a number of times until all sliding sections 11 are extended. Finally, pull both frames 10 away from each other with the braces 40 being straightened.

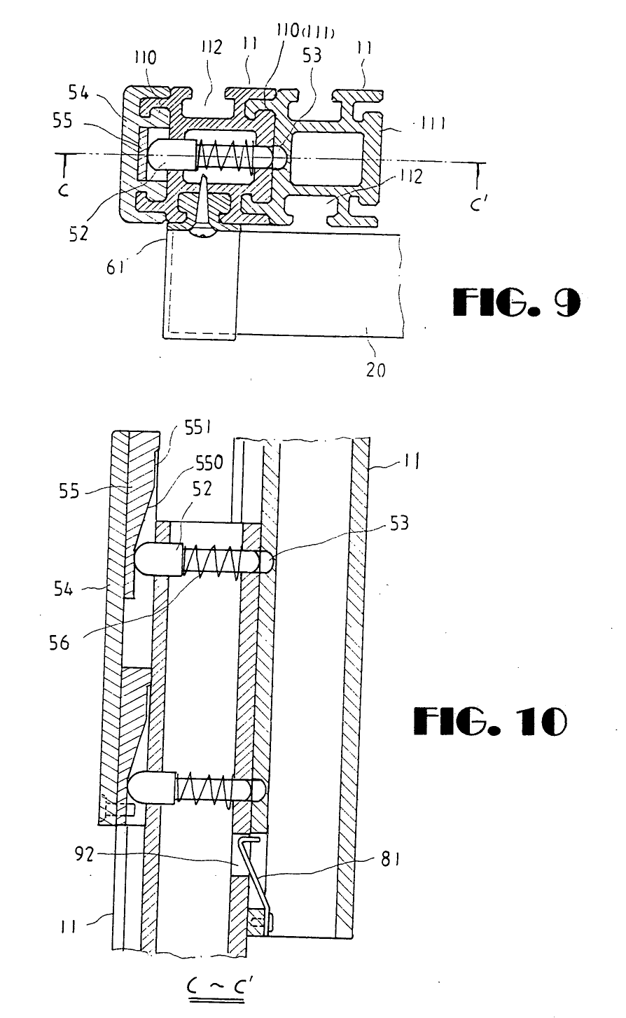

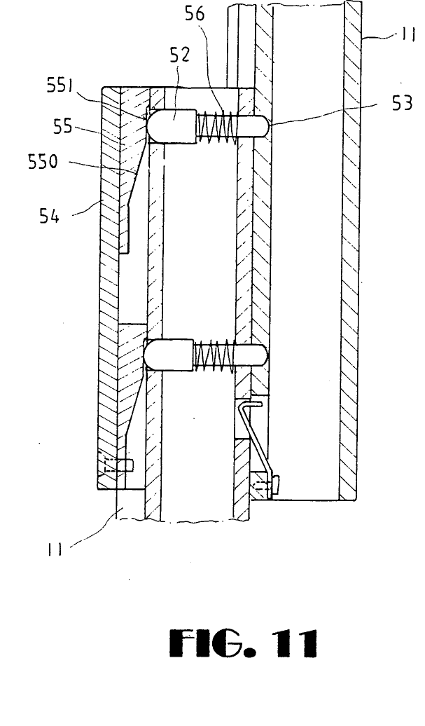

Referring to FIGS. 9, 10 and 11, there is shown a second preferred embodiment of the locking portion of two adjacent sections 11. In the locking portion there are provided two pushing blocks 55 in the outer groove 110 and a sliding member 54 secured onto the pushing blocks 55. The pushing block 55 comprises an upper flat 551, a lower flat, and an intermediate slope 550. In an unlocked position, the rounded head of either spring depressible detent 52 is urged against a joining portion of the lower flat and the slope 550 and the detent 52 clears a recess 53 of a sliding section 11 (see FIG. 10). A user may slide the sliding member 54 downwardly to cause the detent 52 to urge against the flat 551 as the slope 550 moves downward. At this position (see FIG. 11), the rear end of the detent 52 moves in the recess 53 for interlocking two adjacent sections 11 Moreover, the sliding section 11 has an elastic member 81 having a hooked end adapted to move in an aperture 92 of an adjacent section 11 when two adjacent sections 11 have slid to a predetermined position with respect to each other as shown in a lower part of the locking portion in FIG. 10. The provision of the elastic member 81 aims at quickly, precisely aligning the detent 52 with the recess 53 prior to locking by manipulating the sliding member 54.

While the invention herein disclosed has been described by means of specific embodiments, numerous modifications and variations could be made thereto by those skilled in the art without departing from the scope and spirit of the invention set forth in the claims.

1. A telescopic stepladder including two frames hingedly coupled to a top and two lower, folding braces respectively, either frame comprising:
a lowest support section;
one or more sliding sections wherein two side rails of each section are interconnected by one or more steps;
a plurality of locking mechanisms each disposed in either locking portion of two sections and including:
a fastener adapted to fasten the side rail of one section and the side rail of the other section together; and
a lower spring depressible detent adapted to lock both sections;
whereby pushing the braces upward, moving both frames toward each other, unfastening the fasteners, unlocking the detents, and sliding down the sliding sections to a limit will retract the sliding sections with respect to the support sections or the retracted sliding sections; and
pulling the innermost, retracted sliding sections to a limit, locking the detents, fastening the fasteners, and pulling the frames away from each other with the braces being straightened will extend the sliding sections with respect to the support sections or the retracted sliding sections.

2. The telescopic stepladder of claim 1, wherein the side rail includes an outer longitudinal groove having a section of T, an inner longitudinal projection having a section of T, and front and rear longitudinal furrows each having a section of T.

3. The telescopic stepladder of claim 1, wherein each of the sliding sections comprises an aperture adapted to receive a portion of the fastener.

4. The telescopic stepladder of claim 1, wherein each of the sections except the topmost one in a fully extended position has an aperture adapted to receive a head of the detent.

5. A telescopic stepladder including two frames hingedly coupled to a top and two lower, folding braces respectively, either frame comprising:
a lowest support section;
one or more sliding sections wherein two side rails of each section are interconnected by one or more steps;
a plurality of locking mechanisms each disposed in either locking portion of two sections and including:
a plurality of spring depressible detents adapted to lock both sections;
a plurality of pushing blocks disposed in an outer surface of the rail, each pushing block having an inclined portion facing the detent;
a sliding member secured onto the pushing blocks; and
an elastic member disposed in each sliding section, the elastic member having a hooked end adapted to move in an aperture of an adjacent section when two adjacent sections have slid to a predetermined position with respect to each other;
whereby pushing the braces upward, moving both frames toward each other, causing the elastic members to clear the apertures, sliding the sliding members upwardly to cause the detents to unlock two adjacent sections, and sliding down the sliding sections to a limit will retract the sliding sections with respect to the support sections or the retracted sliding sections; and
pulling the innermost, retracted sliding sections to a limit, moving the elastic members in the apertures, sliding the sliding members upwardly to cause the detents to lock two adjacent sections, and pulling the frames away from each other with the braces being straightened will extend the sliding sections with respect to the support sections or the retracted sliding sections.

6. The telescopic stepladder of claim 5, wherein the inclined portion of the pushing block comprises-an upper flat, a lower flat, and an intermediate slope.

7. The telescopic stepladder of claim 5, wherein each of the sliding sections comprises a plurality of recesses adapted to receive a portion of each of the detents.

8. The telescopic stepladder of claim 5, wherein the side rail includes an outer longitudinal groove having a section of T, an inner longitudinal projection having a section of T, and front and rear longitudinal furrows each having a section of T.
